(19) United States
(12) Patent Application Publication
(10) Pub. No.: US 2019/0330508 A1
(43) Pub. Date: Oct. 31, 2019

(54) COMPOSITION AND METHODS FOR COAXIAL DEVICES INCLUDING A PHASE CHANGE MATERIAL

(71) Applicant: E I DU PONT DE NEMOURS AND COMPANY, Wilmington, DE (US)

(72) Inventors: Loic Pierre Rolland, Divonne Les Bains (FR); Laurent Charrel, Habere-Poche (FR)

(21) Appl. No.: 15/966,027

(22) Filed: Apr. 30, 2018

(51) Int. Cl. C09K 5/06; B01J 13/04; B01J 13/22; F28D 15/02; F28D 7/10

(52) U.S. Cl. CPC C09K 5/066; B01J 13/04; F28D 2021/0089; F28D 15/0283; F28D 7/106; B01J 13/22

(57) ABSTRACT

The invention provides processes for making a coaxial device by simultaneously extruding a polymer encapsulation layer defining a hollowed area and filling the hollowed area with PCM composition in liquid form. The invention is useful for thermal management in a variety of applications in such as, for example, automotive, building, packaging, garments, and footwear.

### CROSS REFERENCE TO RELATED APPLICATION

This application claims the benefit of U.S. Provisional Application No. 62/492,318, filed May 1, 2017, the entire contents being incorporated herein by reference.

### BACKGROUND OF THE INVENTION

The present invention relates to the field of phase change materials (PCM) for thermal management in different applications like for example automotive, building, packaging, garments and footwear. In particular, the present invention relates to coaxial devices including a phase change material, the process of making thereof and their use in applications such as automotive.

Phase change materials (PCM) are latent thermal storage materials that are capable of absorbing and releasing high amounts of latent heat during melting and crystallization, respectively. The thermal energy transfer occurs when a material is transformed from a solid to a liquid phase or from a liquid to a solid phase. During such phase changes, the temperature of the PCM material remains nearly constant as does the space surrounding the PCM material, the heat flowing through the PCM being “entrapped” within the PCM itself. Among other well-known PCM, paraffin is frequently used as PCM because of its low cost and low toxicity.

PCM can be introduced in matrices made of different materials or applied to a coating. See, e.g., U.S. Pat. Nos. 4,003,426, 4,528,328, 5,053,446, US2006/0124892 (WO2006/062610), WO98/04644, and WO2004/044345.

However, there is still a need for PCM containing materials that provides high heat storage capacity, high surface contact for optimum thermal exchange, that may be resistant to temperatures from −20° C. to 130° C. under permanent exposure to air but also to chemicals, in particular to lubricating oil and/or to cooling fluid that may remain efficient with time and that may provide high thermal conductivity.

### SUMMARY OF THE INVENTION

In a first embodiment the invention is directed to a process for making a coaxial device including the steps of simultaneously extruding a polymer encapsulation layer defining a hollowed area and filling the hollowed area with PCM composition in liquid form.

In another embodiment, the invention is directed to a coaxial device made by the process as provided herein.

In yet another embodiment, the invention is directed to a coaxial device in the form of a cable made by the process as provided herein.

Also disclosed herein is the use of the cables of the present invention in thermal management, in particular in automotive.

### BRIEF DESCRIPTION OF THE DRAWINGS

FIG. 1 illustrates the process to produce the coaxial device of the present invention; and

FIG. 2 illustrates a latent heat battery prototype and graphed result using the processes and devices of the present invention.

### DETAILED DESCRIPTION

### Definitions

As used herein, the term “a” refers to one as well as to at least one and is not an article that necessarily limits its referent noun to the singular.

As used herein, the terms “about” and “at or about” are intended to mean that the amount or value in question may be the value designated or some other value about the same. The phrase is intended to convey that similar values promote equivalent results or effects according to the invention.

As used herein, the term “acrylate” means an ester of acrylic acid with an alkyl group. Preferred in the invention are acrylates with alkyl groups having 1 to 4 carbon atoms.

As used herein, the term, the term “(meth)acrylic acid” refers to methacrylic acid and/or acrylic acid, inclusively. Likewise, the term “(meth)acrylate” means methacrylate and/or acrylate and “poly(meth)acrylate” means polymers derived from the polymerization of either or a mixture of both corresponding type of monomers.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 18 weight percent of acrylic acid”, or a similar description. Such a description may be considered informal in that it does not refer to the comonomers as copolymerized units; in that it does not include a conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when specified) of the specified comonomers. It follows as a corollary that a copolymer is not the product of a reaction mixture containing given comonomers in given amounts, unless expressly stated in limited circumstances to be such. The term “copolymer” may refer to polymers that consist essentially of copolymerized units of two different monomers (a dipolymer), or that consist essentially of more than two different monomers (a terpolymer consisting essentially of three different comonomers, a tetrapolymer consisting essentially of four different comonomers, etc.).

The term “acid copolymer” refers to a polymer comprising copolymerized units of an α-olefin, an α,β-ethylenically unsaturated carboxylic acid, and optionally other suitable comonomer(s), such as an α,β-ethylenically unsaturated carboxylic acid ester.

The term “ionomer” refers to a polymer that is produced by partially or fully neutralizing an acid copolymer as described above.

In a first embodiment, the invention is directed to a process for making a coaxial device comprising simultaneously extruding a polymer encapsulation layer defining a hollowed area and filling the hollowed area with PCM composition in liquid form. The PCM composition can have any melting point from −50° C. to 150° C.

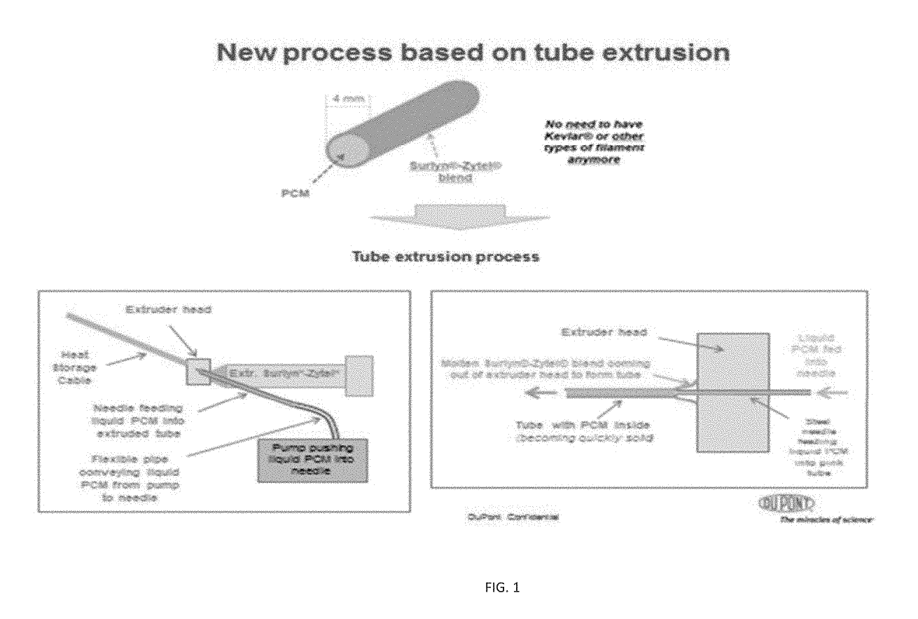

Referring to FIG. 1, the PCM is fed in liquid form in the head of the extruder (through a needle), this can to be done at any temperature above melting point. Simulaneously, the process of the present invention involves extrusion of the polymer encapsulation layer at the same time as feeding the PCM in liquid form. Since the PCM can be fed in liquid form, all of the constraints of processing the PCM in solid form no longer exist. Further, processing of PCM with melting points as low as 27° C. in the method of the present invention can be successfully accomplished without difficulties as recognized in the existing art. However, it should be recognized PCMs with lower melting points than 27° C., e.g. −50° C., can be used in the method.

The extruded polymer encapsulation layer comprises natural or synthetic polymeric material. More particularly, the extruded polymer encapsulation layer can be made of polyamide, a blend of ionomer and polyamide, ethylene acrylate rubber, polyethylene, ethylene copolymers, polypropylene, polyester, all fluorinated polymers including perfluoro ethylene-propylene, perfluoroalkoxy alkane, ethylene tetrafluoroethylene, Polyvinylidene fluoride, and combinations of two or more thereof.

The PCM is chosen among one or more alkyl hydrocarbons (paraffin waxes) or among fatty acids, fatty acid esters, salts of fatty acids, and/or combinations of two or more thereof.

Paraffin waxes are saturated hydrocarbon mixtures and generally consist of a mixture of mostly straight-chain n-alkanes with the chemical formula CH₃—(CH₂)ₙ—CH₃. The crystallization of the —(CH₂)ₙ— chain releases a large amount of the latent heat. Both the melting point and the heat of fusion increase with increasing chain length. Therefore, it is possible to select the paraffin waxes, which are products of petroleum refining, in such a way that the phase change temperature range matches with the temperature of the operation system to which the PCM is applied.

The fatty acids, fatty acid esters, salts of fatty acids can have an origin derived from animal fat, animal grease, vegetable oil, vegetable wax, and/or combinations of two or more thereof.

The fatty acids can be “long” chain fatty acids, both saturated and unsaturated, having tails of more than 12 carbons. Examples of such fatty acids include oleic acid, palmitic acid, linoleic acid, palmitoleic acid, stearic acid, or combinations of two or more thereof. Frequently available fatty acids can be oleic acid, palmitic acid, linoleic acid, palmitoleic acid, stearic acid and/or combinations of two or more thereof.

The fatty acid esters can be formed with alcohols, diols, and/or polyols, including, but not limited to, mono-, di- or triglycerides of glycerol, esters of pentaerythritol, polyesters of polyhydric alcohols, esters of methanol, ethanol, propanol, butanol, isobutanol, pentanol, hexanol, cyclohexanol, esters or diesters of ethylene glycol and/or combinations of two or more thereof. Preferably, the fatty acid esters are mono-, di- or triglycerides of glycerol, and/or combinations thereof.

The composition may additionally comprise from 0.01 to 5, weight percent, based on the total weight of the PCM composition, of additives including primary and secondary antioxidants, ultraviolet ray absorbers, dyes, pigments or other coloring agents, or combinations of two or more thereof. These additives are described in the Kirk Othmer Encyclopedia of Chemical Technology.

The additives may be incorporated into the composition by any known process such as by dry blending, extruding a mixture of the various constituents, the conventional masterbatch technique, or the like.

The process may further include the step of extruding one or more additional layer(s) of a protective polymer onto the extruded tubular polymer encapsulation layer. The additional layer includes one or two layers extruded onto the PCM composition; the first or/and second layer is made of polyamide, a blend of ionomer and polyamide, ethylene acrylate rubber, polyethylene, ethylene copolymers, polypropylene, polyester, all fluorinated polymers including perfluoro ethylene-propylene, perfluoroalkoxy alkane, ethylene tetrafluoroethylene, Polyvinylidene fluoride, and combinations of two or more thereof.

In another embodiment, the invention is directed to a coaxial device produced by the process as provided herein. Most particularly, the coaxial device is in the form of a cable.

Referring to FIG. 1, the cable of the present invention can provide a heat storage capacity in the form of stored energy of at least 100 J/g and which is capable of dissipating 90% of the stored energy within 90 seconds. The cable can maintain a heat storage capacity of 100 to 300 J/g after 18,000 thermal aging cycles-“Thermal ageing cycle” being defined as the manner in which the cable was aged by loading and un-loading heat/energy many times (18 000 times) starting at 23° C., loaded the cable by heating it up to 90° C., then un-loaded it by reducing temperature back to 23° C. The protective layer of the cable degrades less than 50% after 18,000 thermal aging cycles as measured by tensile strength.

The devices of the present invention can be used in several applications where thermal management is needed. While temperature management inside buildings is one of the most relevant applications, the device of the of the present invention may also be used in automotive applications (for example for latent heat batteries, thermal management of electrical batteries, ceiling and seats of vehicles); air filters in air ducts; air conditioners; transportation applications; food packaging (to keep food chilled or warm); medical packaging (for example organ or vaccine transportation); woven and nonwoven fabrics for garments, clothes and sport wear; footwear; tree wraps, bedding; carpets; wood composites; electric cables and plastic tubes for hot media including water.

A particularly preferred application is in latent heat batteries of cars where energy is stored in the cables of the present invention while the engine is in operation and where the cables are able to release the energy stored when necessary (for instance for start-up in cold environment or cold season). This energy release allows to reduce viscosity of lubricating oils and cooling fluids and ultimately leads to lower fuel consumption and reduced CO² emission.

In a particular embodiment, the invention is directed to a method to thermally manage a lubricating oil or cooling fluid within a device, e.g. engine during ignition. The method includes the steps of installing a coaxial device, for example, a cable of the present invention as key component of a latent heat accumulator device in communication with a mechanical device. The mechanical device will provide a source of lubricating oil or cooling fluid. The lubricating oil or cooling fluid flows from the source of lubricating oil or cooling fluid via the latent heat accumulator to an “engine” during ignition. The cable discharges heat/energy reducing the viscosity of the lubricating oil or cooling fluid and the energy needed to pump the lubricating oil or cooling fluid within the mechanical device during ignition.

### Examples

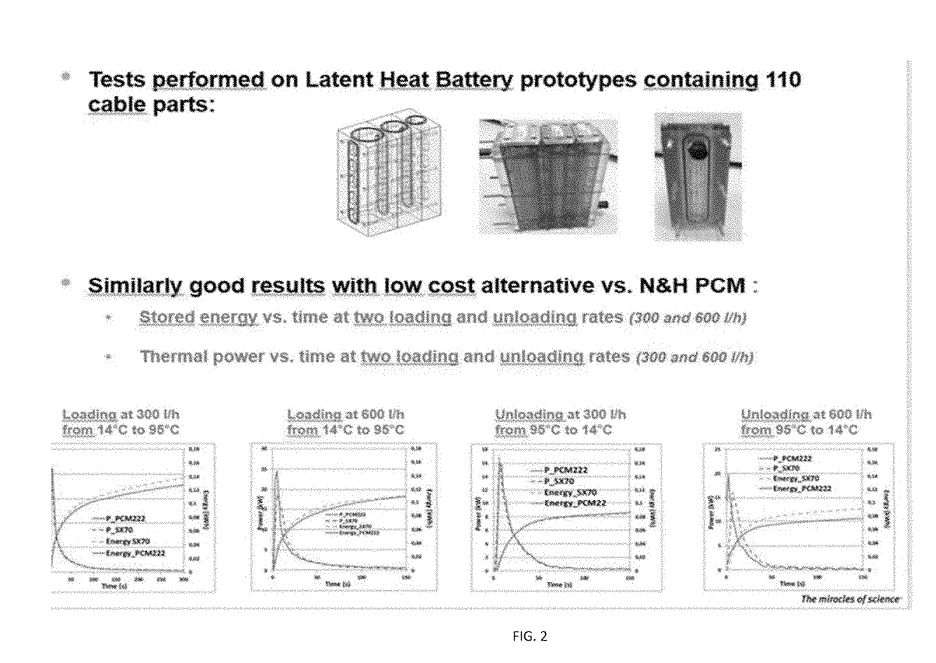

Several hundreds meters of coaxial device having a diameter of 4 mm, a wall thickness of 0.2 mm and containing a paraffin based PCM having a melting point of 70° C., have been produced using the process described in this application. Referring to FIG. 2, 110 parts of the produced coaxial device, having each a length of 20 cm have then been cut out from the lengths made. Each of these parts has then been closed at their two ends by aluminum plugs.

A latent heat battery prototype has then been built by inserting these 110 parts into a closed metal box perforated by 2 holes (around 10 mm in diameter). These two holes were positioned on opposite sides of the box and as far as possible from each other (next to opposite adjacent sides of the box). This latent heat battery prototype has then been put in an oven at 95° C. during several hours until all the 110 parts have reached this temperature. A lubricating oil at a temperature of 14° C. has then been fed at a rate of 300 liters per hour into the box through one of the two holes (the inlet) and during 300 seconds. The oil has been recovered out of the second hole of the box (the outlet). The energy absorbed by the lubricating oil coming out of the box has been recorded during the whole duration of the test.

### Results

The measuring equipment recorded that the oil absorbed 72 Wh after 35 seconds and 108 Wh after 135 seconds. These results are considered as highly valuable since they mean that in a car engine, oil at a temperature of 14° C. could be immediately heated up through such latent heat battery and injected in the engine at a temperature of 55° C. after only 150 seconds after a cold-start of the car. This means a significantly lower oil viscosity and a consequent lower fuel comsumption. For comparison, without such latent heat battery, 150 seconds after a cold-start, the same oil would be injected at only 21° C. in the engine.

What is claimed is:

1. A process for making a coaxial device comprising simultaneously extruding a polymer encapsulation layer defining a hollowed area and filling the hollowed area with PCM composition in liquid form.

2. The process of claim 1, wherein the PCM composition can have any melting point from −50° C. to 150° C.

3. The process of claim 2, wherein the extruded polymer encapsulation layer comprises natural or synthetic polymeric material

4. The process of claim 3, wherein the extruded polymer encapsulation layer is made of polyamide, a blend of ionomer and polyamide, ethylene acrylate rubber, polyethylene, ethylene copolymers, polypropylene, polyester, all fluorinated polymers including perfluoro ethylene-propylene, perfluoroalkoxy alkane, ethylene tetrafluoroethylene, Polyvinylidene fluoride, and combinations of two or more thereof.

5. The process of claim 4, further comprising the step of extruding one or more additional layer(s) of a protective polymer onto the extruded polymer encapsulation layer.

6. The process of claim 5, wherein the additional layer comprises one or two layers extruded onto the polymer encapsulation layer composition; the first or/and second layer is made of polyamide, a blend of ionomer and polyamide, ethylene acrylate rubber, polyethylene, ethylene copolymers, polypropylene, polyester, all fluorinated polymers including perfluoro ethylene-propylene, perfluoroalkoxy alkane, ethylene tetrafluoroethylene, Polyvinylidene fluoride, and combinations of two or more thereof.

7. A coaxial device made by the process of claim 6.

8. The coaxial device of claim 7, wherein the coaxial device is in the form of a cable.

9. The cable of claim 8, which provides a heat storage capacity in the form of stored energy of at least 100 J/g and which is capable of dissipating 90% of the stored energy within about 90 seconds.

10. The cable of claim 8, which maintains heat storage capacity of 100 to 300 J/g after 18,000 thermal aging cycles.

11. The cable of claim 8, wherein the protective layer degrades less than 50% after 18,000 thermal aging cycles as measured by tensile strength.

12. The use of the cable of claim 8 in thermal management.

13. The use of the cable of claim 8 in the automotive industry.

14. The use of the cable of claim 8 in electrical and heat batteries.

15. A method to effect the temperature of a lubricating oil or cooling fluid within a mechanical device during ignition comprising:
attaching the cable of claim 11 to a latent heat accumulator device;
(ii) providing a mechanical device;
(iii) providing a source of lubricating oil or cooling fluid
(iv) flowing the lubricating oil or cooling fluid from the source of lubricating oil or cooling fluid via the latent heat accumulator to the mechanical device during ignition,
wherein the cable discharges heat/energy reducing the viscosity of the lubricating oil or cooling fluid and the energy needed to pump the lubricating oil or cooling fluid within the mechanical device during ignition.
